(19) United States
(12) Patent Application Publication
(10) Pub. No.: US 2003/0191675 A1
(43) Pub. Date: Oct. 9, 2003

(54) Recycling method and recycling system

(75) Inventor: Kimitaka Murashita, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/407,330

(22) Filed: Apr. 7, 2003

(30) Foreign Application Priority Data
Apr. 8, 2002 (JP) 2002-104881

(51) Int. Cl. G06F 17/60

(52) U.S. Cl. 705/7

(57) ABSTRACT

In a recycling method, a person or organization of responsibility for the disposal of a product in a life cycle from production to disposal of the product stores in a storage unit an electronic certificate indicating that the person or organization of responsibility has performed an appropriate process corresponding to the responsibility.

### BACKGROUND OF THE INVENTION

1. Field of the Invention

The present invention relates to waste disposal and a recycling system for industrial products, etc., and more specifically to a recycling method for storing, for example, in the memory attached to a product an electronic certificate of an appropriate process correctly performed by a person of responsibility for the disposal of the product.

2. Description of the Related Art

Recently, disposing wastes from households and companies has become a serious social problem. To solve the problem, there has been a system of sharing a part or all of the costs of the disposal of, for example, industrial products by manufacturers, consumers, etc. The household electric appliance recycling law has been effective on several items of household electric appliances, such as, televisions, refrigerators, air-conditioners, washing machines, etc. For example, consumers are to share the costs.

However, the household electric appliance recycling law does not clearly describe, for example, the sharing rate of the costs among the persons of responsibility for the disposal, etc., and there is the impression that the burden of the consumers is partially large. Therefore, all consumers do not support the law, thereby causing a new problem of contributory to illegal dumping.

There are the documents about the above mentioned recycling systems as follows.

Document 1: Japanese Patent Laid-open No.2000-76334 ‘Collecting/Recycling Charge Payment Method, System, and Apparatus using Electronic Tag and Electronic Money’

Document 2: Japanese Patent Laid-open No.2000-242752 ‘Apparatus having Recycling Information Storage Medium’

In the document 1, the charge from a collector/recycler is compared with the upper limit payable by a manufacturer, and, if the charge is equal to or smaller than the upper limit, then the electronic money is recorded on the electronic tag, the collecting/recycling process is appropriately performed, the electronic money on the electronic tag is transferred to the device of the collector/recycler, thereby completing the payment process.

The document 2 discloses the system of easily and efficiently performing a recycling operation according to the recycling information by providing a built-in information storage medium such as an IC card, etc. in the apparatus, and reading the recycling information stored in the information storage medium and the identification information specific to a product.

In the above mentioned recycling system for the disposal of waste, etc., a question arises: Who is to pay the cost of the disposal and recycling? In the life cycle from production to disposal of products, there are plural persons or organizations of responsibility for the disposal of products such as manufacturers, retailers, consumers, collectors, scrappers, etc. Therefore, it is the problem: How the recycling cost is to be shared among the persons or organizations of responsibility, and how the recycling process is to be distributed to the recyclers such as collectors, scrapper, etc.

Then, it is important to give no impression of partiality each of the persons or organizations of responsibility, and to publish among the persons or organizations of responsibility that the responsibility is correctly exercised by each person or organization of responsibility. In the technology disclosed by the documents 1 and 2, there have been the problems of the impression of partiality among persons or organizations of responsibility, and the uncertain processes of the responsibility exercised by other persons or organizations of responsibility.

### SUMMARY OF THE INVENTION

The present invention has been developed to solve the above mentioned problems, and aims at providing a recycling method and a recycling system capable of clarifying the cost shared among persons or organizations of responsibility and publishing among persons or organizations of responsibility the responsibility is correctly exercised by each person or organization of responsibility.

In a recycling method according to the present invention, a person or organization of responsibility for disposal of a product in a life cycle from production to disposal of the product stores in a storage unit an electronic certificate indicating that the person or organization of responsibility has performed an appropriate process corresponding to the responsibility.

A recycling management apparatus according to the present invention includes: a unit for managing a product recycling process and checking the contents of an electronic certificate which is issued to persons or organizations of responsibility for the disposal of products in the life cycle from production to disposal of the products, and indicates that each person or organization of responsibility has appropriately performed the process corresponding to his or her own responsibility; a unit for receiving from a certificate authority the electronic certificate indicating that the contents of the electronic certificate has been checked; and a unit for transmitting the received electronic certificate to a settling authority and requesting the settling authority to settle the payment of the recycling cost.

Furthermore, a recycling system according to the present invention is configured by a computer provided for each of the persons or organizations of responsibility for the disposal of products in the life cycle from production to disposal of products, and includes a recycling management server having a disposing step storage unit for storing a disposing step stored by a manufacturer of the product corresponding to one or more identifiers already stored in the memory attached to the product, and a disposing step stored by a recycler of the product and is to be performed by the recycler.

Thus, according to the present invention, for example, ferroelectric memory attached to a product stores an electronic certificate, issued by a certificate authority, indicating that each person or organization of responsibility has appropriately performed the process corresponding to the responsibility assigned to each person or organization of responsibility. Therefore, the cost sharing can be clarified among the persons or organizations of responsibility, and the fact that each person or organization of responsibility has appropriately performed the process corresponding to the responsibility of each person or organization of responsibility can be published among the persons or organizations of responsibility.

### BRIEF DESCRIPTION OF THE DRAWINGS

FIG. 1 shows the principle of the recycling method according to the present invention;

FIG. 2 shows the recycling process considered at the production/purchase of a product;

FIG. 3 shows the basic process when a product is disposes or recycled;

FIG. 4 shows the electronic certificate issuing process according to the first embodiment of the present invention;

FIG. 5 shows the process including the certification of an electronic certificate already stored in memory;

FIG. 6 shows the electronic certificate storing process including a payment of a recycling cost;

FIG. 7 shows the process including a payment of the cost to a recycler;

FIG. 8 shows the process when a recycling cost is stored in memory as electronic money;

FIG. 9 shows the record of the reserve for the recycling cost from production to purchase of a product;

FIG. 10 shows the record of the reserve for the cost recorded when a product is disposed or recycled;

FIG. 11 show the storage of recycling information in ferroelectric memory;

FIG. 12 shows an example of a read and display of recycling information stored in the ferroelectric memory;

FIG. 13 shows an example of the configuration of the data in the ferroelectric memory containing recycling information;

FIG. 14 shows an example of the configuration of the storage device including the ferroelectric memory;

FIG. 15 shows the configuration of a recycling system according to the second embodiment of the present invention including a recycling management server;

FIG. 16 shows the process from a notification of disposal to a recycling management server to a request for recycling according to the second embodiment of the present invention;

FIG. 17 shows an example of an ID associated with a disposing step stored in memory;

FIG. 18 shows the procedure of a recycling process corresponding to the step;

FIG. 19 shows an example of the contents of the storage of the disposing step which can be performed by a recycler;

FIG. 20 is a block diagram of an example of the configuration of a recycling management server;

FIG. 21 is a block diagram of the entire configuration of the recycling system according to the second embodiment of the present invention;

FIG. 22 is a flowchart of the recycling process by a manufacturer;

FIG. 23 is a flowchart of the recycling process by a retailer;

FIG. 24 is a flowchart of the recycling process by a consumer;

FIG. 25 is a flowchart of the process by a recycler;

FIG. 26 is a flowchart (1) of the settling process by a settling agent;

FIG. 27 is a flowchart (2) of the settling process by a settling agent;

FIG. 28 is a flowchart (3) of the settling process by a settling agent;

FIG. 29 is a flowchart of the entire recycling process centering on the process performed by a recycling manager; and

FIG. 30 is an explanatory view of loading a program into a computer according to the present invention.

### DETAILED DESCRIPTION OF THE INVENTION

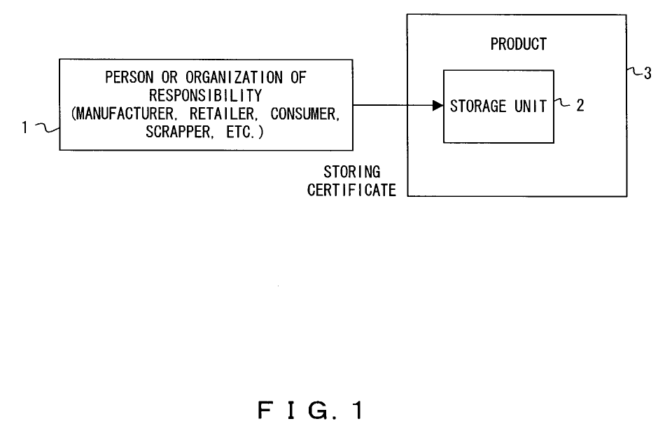

FIG. 1 is an explanatory view showing the function based on the principle of the recycling method according to the present invention. In FIG. 1, an electronic certificate certifying that a person or organization of responsibility 1 for the disposal of a product, for example, a manufacturer, a retailer, a consumer, a scrapper, etc. has appropriately performed a process corresponding to his or her own responsibility in the life cycle from production to disposal of a product is stored in a storage unit 2.

According to an embodiment of the present invention, the storage unit 2 is, for example, ferroelectric memory attached to a product 3, an electronic certificate can be issued by an officially established certificate authority, and the certificate authority can issue an electronic certificate using a certification key as a secret key.

According to an embodiment of the present invention, the certificate authority can also authenticate the electronic certificate already stored in the storage unit 2.

When a person or organization of responsibility pays a recycling cost to a settling authority, the certificate authority can store the amount of the recycling cost in the electronic certificate. In this case, the settling authority can issue the electronic money for the recycling cost, and the person or organization of responsibility can store the electronic money in the storage unit 2. Furthermore, when the electronic money is stored, a data processing unit connected to the storage unit 2 can issue a certification of the storage of the electronic money.

According to an embodiment of the present invention, when a person or organization of responsibility requests a certificate authority for a recycling cost of the process, a settling authority can pay the recycling cost to the person or organization of responsibility after receiving a notification from the certificate authority to the settling authority.

According to an embodiment of the present invention, before a consumer purchases a product, a person or organization of responsibility, for example, a manufacturer can store in the storage unit 2 the data relating to a person or organization of responsibility at the time of the disposal of the product, and the data of the person or organization of responsibility can be displayed to another person or organization of responsibility.

Furthermore, according to an embodiment of the present invention, a person or organization of responsibility can also read/write the data relating to the storage unit 2 using a non-contact memory access device, and a predetermined person or organization of responsibility in a plurality of persons or organizations of responsibility can initialize the contents stored in the storage unit 2 using an initialization key.

The recycling system according to the present invention is configured by a computer provided for each person or organization of responsibility, and comprises a recycling management server having a storage unit for storing a disposing step corresponding to one or more identifiers stored by a manufacturer of a product and already stored in the memory attached to the product, and for storing a disposing step which is stored by a recycler of the product and can be performed by a recycler.

According to an embodiment of the present invention, a recycling management server can further comprise a recycler selection unit for selecting a recycler of a product based on one or more identifiers stored in the memory corresponding to the notification of the disposal of the product from a consumer, the storage unit can further store the recycling cost corresponding to the disposing step stored by the recycler of the product, the recycler selection unit can select a recycler based on the recycling cost, and the memory can also store the electronic certificate stored by a person or organization of responsibility.

The recycling management apparatus according to the present invention comprises: a unit for checking the contents of the electronic certificate issued to a person or organization of responsibility; a unit for receiving from a certificate authority an electronic certificate indicating that the contents have been checked; and a unit for transmitting the received electronic certificate to a settling authority and requesting the settling authority to pay the recycling cost.

In the present invention, a program executed by a computer used by a person or organization of responsibility can be a program for directing a computer to follow the procedure of the person or organization of responsibility receiving an issued electronic certificate indicating that the process corresponding to the responsibility of the person or organization of responsibility has been appropriately performed, and the procedure of storing the issued electronic certificate in the storage unit. Additionally, a computer-readable portable storage medium storing the program is also used.

As described above, according to the present invention, for example, the ferroelectric memory attached to a product stores an electronic certificate which is issued by a certificate authority and indicates that each person or organization of responsibility has appropriately performed the process corresponding to his or her responsibility.

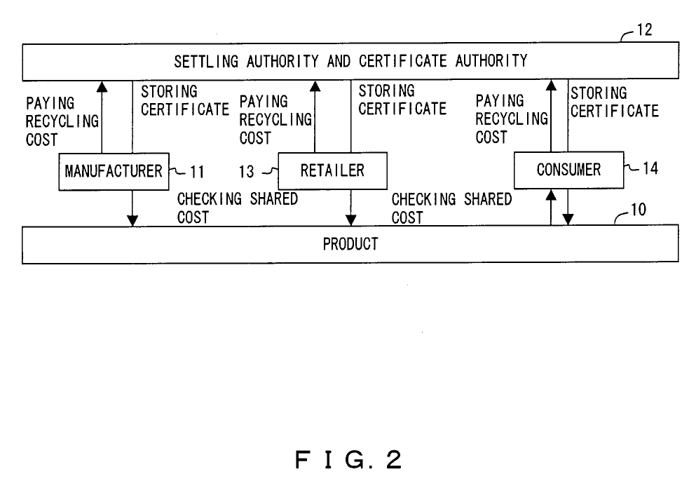

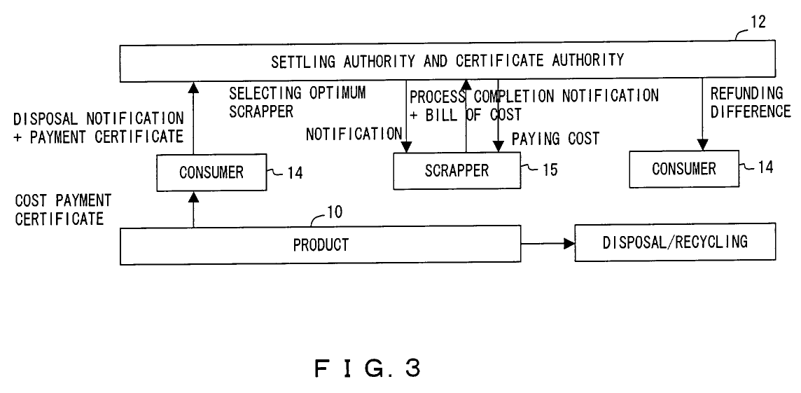

According to the present invention, a person or organization of responsibility such as a manufacturer, a retailer, and a consumer of a product to be recycled, a collector and a scrapper working for the disposal of the product, an organization for managing a recycling process, etc. stores in the memory, for example, attached to the product an electronic certificate indicating that the respective processes have been appropriately performed for the recycling process. Before explaining in detail the embodiments, the outline of the processes performed by the respective persons or organizations of responsibility when the product is produced, purchased, and disposed are described below by referring to FIGS. 2 and 3.

FIG. 2 shows the recycling process performed for a product when it is produced and purchased. In FIG. 2, a manufacturer 11 of a product 10 pays the recycling cost to be shared as a manufacturer to a settling authority and a certificate authority 12 when the product 10 is produced, and stores in the memory attached to the product 10 the electronic certificate issued by the settling authority and the certificate authority 12 corresponding to the payment. The memory can be common flash memory or EPROM, but quick access can be realized by using a ferroelectric RAM (FRAM, a registered trademark) whose cell is ferroelectric, thereby performing a write of data over 10⁹ times. A large number of memory elements are required by attaching such memory to the product 10.

The retailer 13 of a product checks the cost to be shared as a retailer by referring to the contents stored in the memory attached to the product 10, pays the recycling cost corresponding to the checked cost to the settling authority and the certificate authority 12, and stores the issued electronic certificate in the memory attached to the product 10. The contents of the cost to be shared by the retailer are stored in the memory in advance, for example, by the manufacturer 11.

When the consumer purchases a product, he or she checks the cost to be shared as a consumer similarly by referring to the contents of the memory, pays the corresponding recycling cost to the settling authority and the certificate authority 12, and stores the issued electronic certificate in the memory attached to the product 10. Checking the cost to be shared by a consumer 14 and paying the recycling cost can be performed by a retailer 13 for the consumer.

FIG. 3 shows the basic process performed when a product is disposed or recycled. The consumer 14 reads from the memory attached to the product a certificate indicating that the manufacturer 11, the retailer 13, and the consumer 14 have paid the respective costs, and notifies the settling authority and the certificate authority 12 of the certificate together with the request to dispose the product.

In response to the request, the settling authority and the certificate authority 12 selects the optimum scrapper in the method described below, requests a scrapper 15 to dispose the product. The scrapper 15 performs a process for disposal of the product 10, transmits a process completion notification and a request to pay the cost to the settling authority and the certificate authority 12, and receives the payment. If there is an overpayment of the recycling cost, the residue is refunded to, for example, the consumer 14.

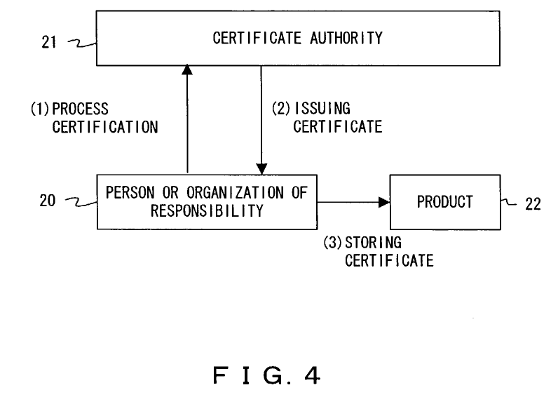

Described next in detail is the first embodiment of the present invention. FIG. 4 shows the electronic certificate issuing process by a certificate authority (CA). In FIG. 4, a person or organization of responsibility 20 such as a manufacturer, a retailer, a consumer, etc. transmits a certificate (application) indicating that the person or organization of responsibility has performed an appropriate process for recycling the product, and requests a certificate authority 21 to issue an electronic certificate in (1).

The certificate authority 21 examines the contents of the application from the person or organization of responsibility 20, issues an electronic certificate indicating that the person or organization of responsibility 20 has exercised an assigned responsibility in (2), and the person or organization of responsibility 20 stores the electronic certificate in the memory attached to, for example, a product 22 in (3). The certificate authority 21 can certify the recycling process only, but can also officially certify an electronic signature and an electronic document.

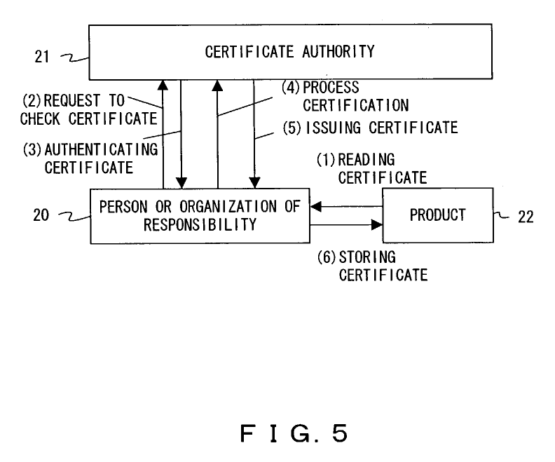

FIG. 5 shows the process including the certification of an electronic certificate stored in the memory attached to the product. In FIG. 5, the person or organization of responsibility 20 such as a consumer reads from the product 22 an electronic certificate issued to, for example, a manufacturer and a retailer and stored in the memory attached to the product 22 before purchase of the product in (1), and requests the certificate authority 21 to confirm the certificate in (2). In response to the request, the certificate authority 21 confirms the certificate, and notifies the person or organization of responsibility 20 of the authentication in (3).

The person or organization of responsibility 20 such as a consumer determines based on the authentication that a manufacturer, a retailer, etc. have appropriately performed the processes for recycling before the consumer performs his or her process, presents to the certificate authority 21 a self certificate that the consumer has performed his or her own process for recycling in (4), receives an issued electronic certificate corresponding to the process performed by the consumer in (5), and stores it in the memory attached to the product 22 in (6). If each person or organization of responsibility determines that an appropriate cost has not been paid in the preceding stages, he or she can reject receiving the product.

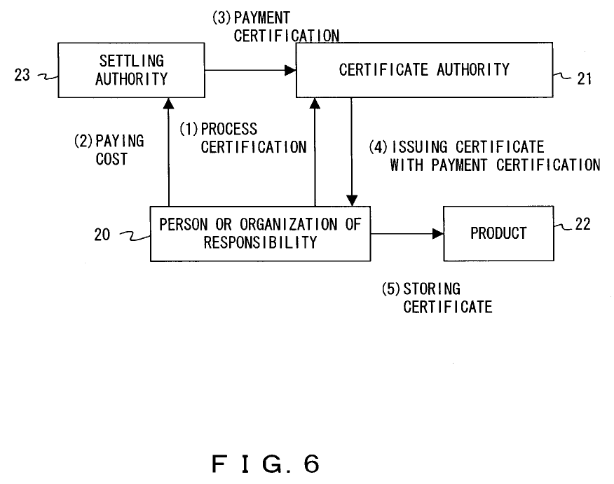

FIG. 6 shows the electronic certificate storing process including the payment of the recycling cost. In FIG. 6, the person or organization of responsibility 20 issues to the certificate authority 21 in (1) similarly as shown in FIG. 4 a certification that an appropriate process for recycling has been performed, for example, that a manufacturer has produced the product 22 using a material suitable for recycling, and pays the recycling cost to be shared by the manufacturer to a settling authority 23 in (2).

The settling authority 23 transmits to the certificate authority 21 a certification that the cost has been paid in (3). In response to the certification, the certificate authority 21 issues an electronic certificate with certification of payment to the person or organization of responsibility 20 in (4), and the person or organization of responsibility 20 stores the certificate in the memory attached to the product 22 in (5), thereby terminating the process. In this process, the settling authority 23 is different from the certificate authority 21, but it is obvious that one authority unit can have both functions.

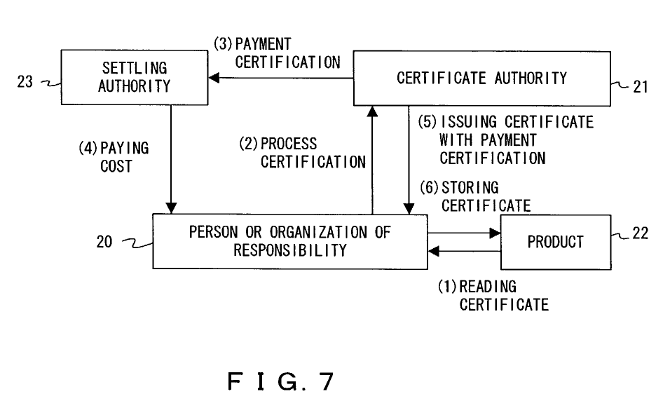

FIG. 7 shows the process including the payment of the recycling costs to collectors/scrappers for performing their respective processes. In FIG. 7, for example, the person or organization of responsibility 20 as a collector requested by the consumer to collect a product to be disposed reads an electronic certificate from the memory attached to the product 22 in (1), and transmits to the certificate authority 21 a certification of the process indicating that the product 22 has been transmitted to the scrapper, for example, according to the information from the scrapper stored with the electronic certificate as described later in (2).

The certificate authority 21 transmits to the settling authority 23 a certification that the recycling cost can be paid in (3), and the settling authority 23 pays the cost to the person or organization of responsibility 20 in (4). If the person or organization of responsibility 20 has a further process of a scrapper to be performed as, for example, a collector, then a payment reservation is made instead of an actual payment in (4).

The certificate authority 21 issues an electronic certificate with certification of payment to the person or organization of responsibility 20 in (5), and the person or organization of responsibility 20 stores the certificate in the memory attached to the product 22 in (6), thereby terminating the process. The electronic certificate with certification of payment certifies that the person or organization of responsibility has correctly performed the recycling process, and has paid the cost for the recycling process or made a payment reservation.

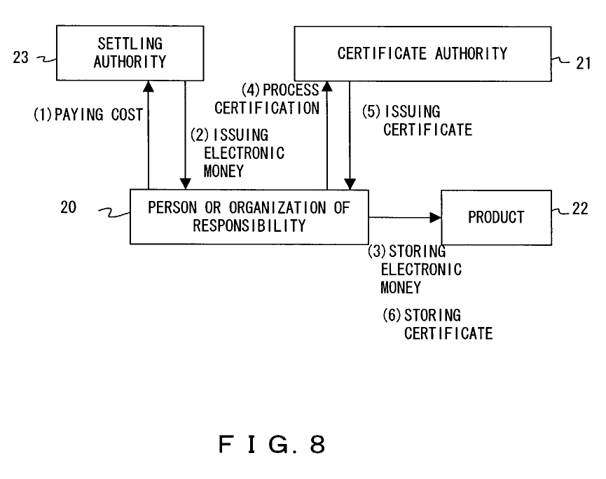

FIG. 8 shows the process performed when the recycling cost is stored as electronic money in the memory attached to the product. In FIG. 8, the person or organization of responsibility 20 pays the recycling cost to the settling authority 23 in (1), receives issued electronic money in (2), and stores the electronic money in the memory attached to the product in (3).

Including the storage of the electronic money, a certification that the recycling process has been appropriately performed is transmitted to the certificate authority 21 in (4), the certificate authority 21 issues an electronic certificate in (5), and the certificate is stored in the memory attached to the product 22 in (6).

In FIG. 8, the person or organization of responsibility 20 stores electronic money in (3), and can notify the certificate authority 21 of the electronic money storage certificate issued by the product 22 side as attached to the process certification in (4). In this case, it is necessary to issue an electronic money storage certificate on the product 22 side. The product 22 requires a data processing device for performing a process of issuing a certificate, etc. in addition to the memory for storing data.

Instead of storing electronic money in the memory attached to the product 22, the electronic money can be stored, for example, in the electronic money storage device provided in a remote server through network. In this case, the memory stores only a certificate indicating that electronic money is stored in the server.

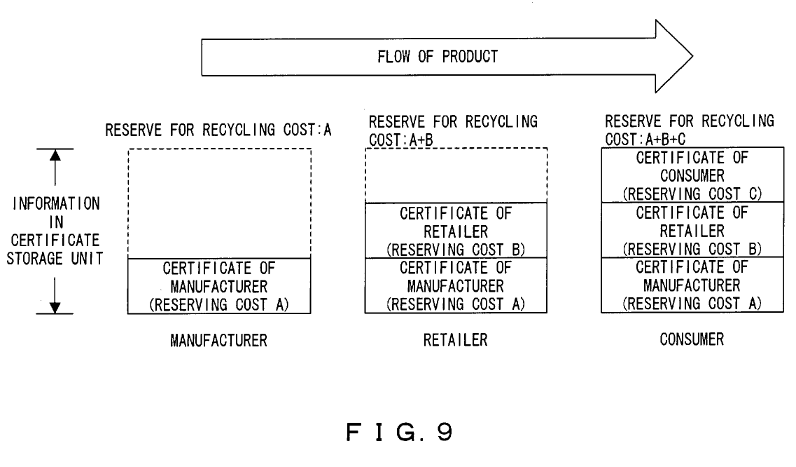

FIG. 9 shows the information about the certificate in the memory attached to a product, and the record of the reserve for the recycling cost from production to purchase of a product. In FIG. 9, the manufacturer stores in the certificate storage unit in the memory a certificate issued by a certificate authority to the manufacturer, and the certificate also indicates the reservation of the recycling cost A.

At the stage of a retailer, in addition to the certificate to a manufacturer, a certificate issued by a certificate authority to the retailer is also stored, and the reserve for the recycling cost is obtained by adding the value of B reserved by the retailer to the value of A reserved by the manufacturer.

At the stage of a consumer, a certificate issued by a certificate authority to the consumer is also stored, and the reserve for the recycling cost is obtained by adding the cost C reserved by the consumer.

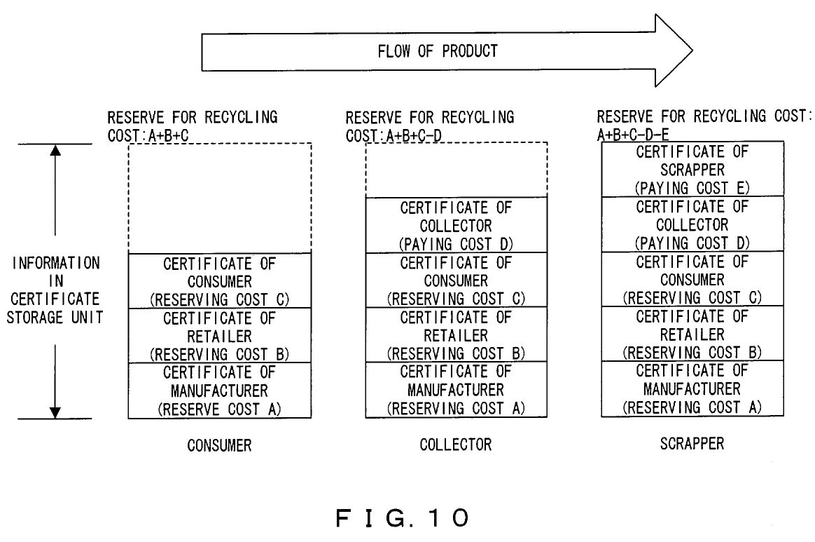

FIG. 10 shows the information stored in the certificate storage unit in the memory when the product is disposed or recycled, and the record of the reserve for the recycling cost. The stage of the consumer is the same as the stage shown in FIG. 9. At the stage of a collector, a certificate issued by a certificate authority to the collector is stored in the certificate storage unit, and the certificate indicates that the cost D is to be paid to the collector. At this stage, the reserve for the recycling cost is computed by A+B+C−D.

At the stage of a scrapper, a certificate issued to the scrapper is stored. The certificate indicates that the cost E is to be paid to the scrapper, and the reserved recycling cost is computed by A+B+C−D−E.

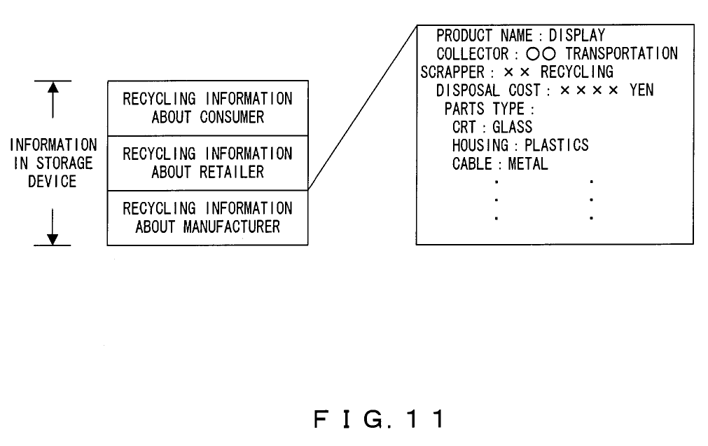

FIG. 11 show the storage device attached to a product, for example, the contents of the storage of recycling information in ferroelectric memory. In FIG. 11, as the recycling information about a manufacturer, for example, the names of a collector and a scrapper recommended by a manufacturer, the amount of disposal cost, the type of parts, etc. are stored.

As the recycling information about a consumer shown in FIG. 11 can be recycling information, etc. defined by local administration of the district in which a consumer lives. When a product is disposed, a consumer reads the recycling information from the memory attached to the product 22, and starts the disposing process according to the optimum recycling information, for example, the least expensive information.

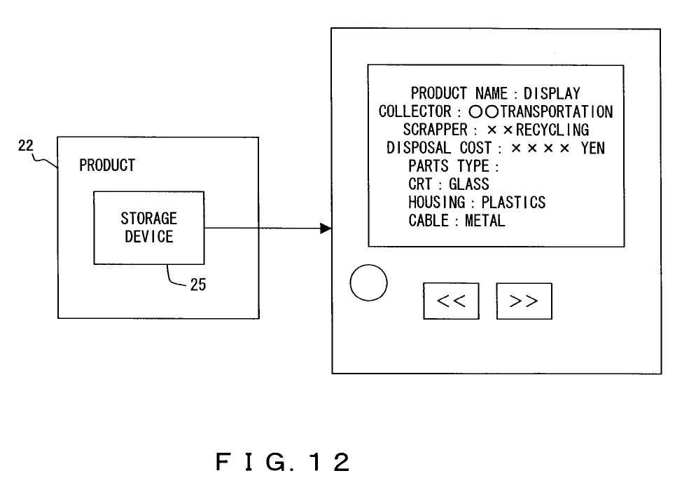

FIG. 12 shows an example of displaying the recycling information stored in a storage device 25 attached to the product 22, for example, ferroelectric memory. For example, a consumer can be informed of a collector, etc. based on the display result.

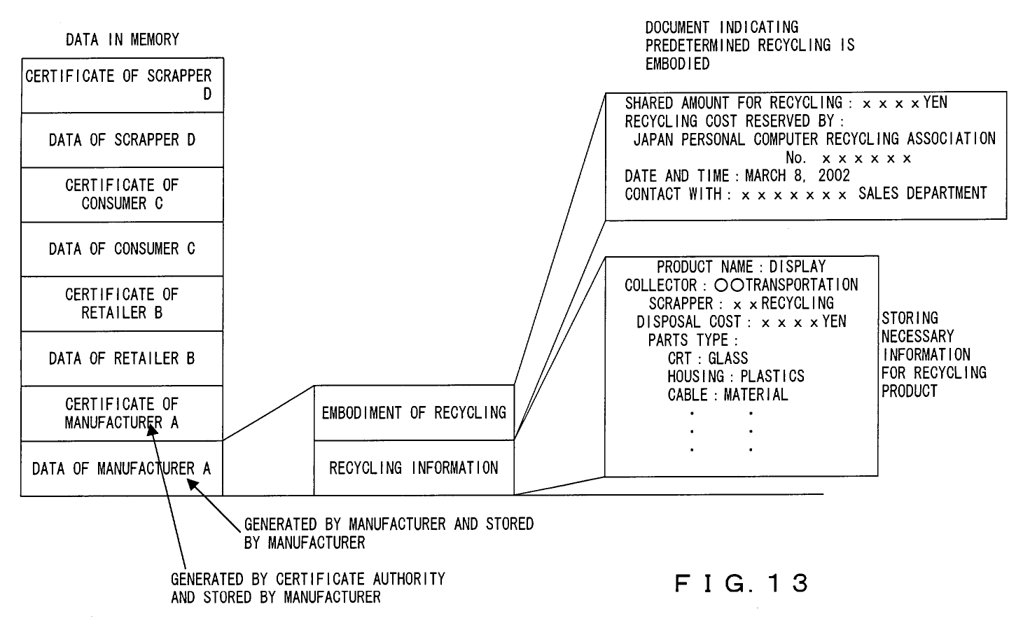

FIG. 13 shows an example of data stored in a storage device 25. For example, the recycling information generated by a manufacturer A and a recycling embodiment certification are stored as data of the manufacturer A.

The recycling information is required for recycling of the product shown in FIG. 11, and the recycling embodiment certification is a document indicating that a predetermined recycling operation has been performed, and stores an amount of recycling cost to be shared, the stage where a recycling cost is reserved, etc.

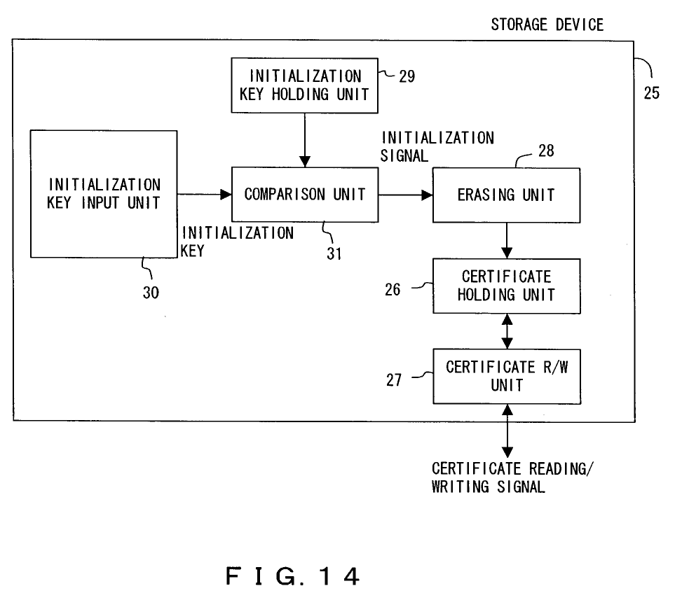

FIG. 14 shows an example of the configuration of the storage device 25 shown in FIG. 12. In FIG. 14, the storage device 25 comprises: a certificate holding unit 26 for holding an electronic certificate issued by a certificate authority; a certificate R/W unit 27 for reading/writing data on the certificate holding unit 26; a erasing unit 28 for erasing a certificate held in the certificate holding unit 26; an initialization key holding unit 29 for holding an initialization key required in erasing a certificate; an initialization key input unit 30 for receiving an initialization key externally input for erasure of a certificate; and a comparison unit 31 for comparing the input initialization key with the key stored in the initialization key holding unit 29, and outputting an initialization signal to the erasing unit 28 when the comparison outputs a coincident result.

In FIG. 14, the initialization key is generated by any person or organization of responsibility, for example, a manufacturer. When a product is produced by the manufacturer, finally disposed by a scrapper, and the life cycle is over, only the storage device is returned to the manufacturer, and can be newly used for another product after the initialization.

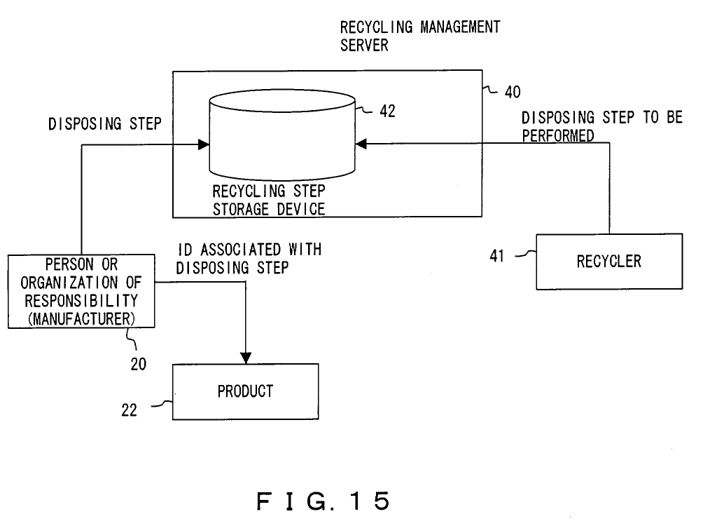

Then, the recycling system using a recycling management server is described below as the second embodiment according to the present invention. According to the second embodiment, a recycling management server 40 is provided in the system as shown in FIG. 15 for centrally managing the recycling process performed by a recycler 41, that is, a collector and a scrapper. The recycling management server can be provided as a service of an application service provider which also provides a service including a settling system.

In the recycling management server 40, aside from the storage device (memory) attached to the above mentioned product 22, a recycling step storage device 42 for storing a recycling step, procedure, and cost is provided. In the recycling step storage device 42, one or more disposing steps normally comprising a plurality of procedures are stored by a person or organization of responsibility, for example, by a manufacturer 20 for each product, and an ID corresponding to the disposing step which can be performed by the recycler and the recycling cost corresponding to the disposing step are stored by the recycler 41. Additionally, the memory attached to the product 22 stores an ID corresponding to one or more disposing steps of the product.

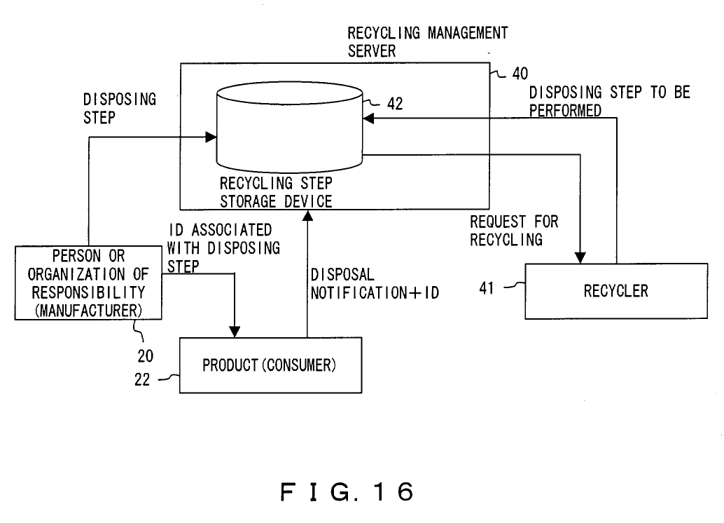

FIG. 16 shows the process from a disposal notification from a consumer to a request for recycling to a recycler as shown in FIG. 15. In FIG. 16, in addition to the disposal notification from a consumer corresponding to a product 22, an ID associated with one or more steps of the recycling process is read from the memory, and the ID is provided for the recycling management server 40.

The recycling management server 40 selects, for example, a recycler of the smallest cost corresponding to an ID transmitted from a consumer based on the ID stored in advance by the recycler 41 and corresponding to the disposing step which can be performed by the recycler 41 as described above by referring to FIG. 15 and the contents of the stored recycling cost, and requests the recycler 41 to perform the recycling process. Actually, the distribution cost such as collection and transportation costs, etc. is required, and a recycler has to be selected based on the total cost including the distribution cost in addition to the recycling cost.

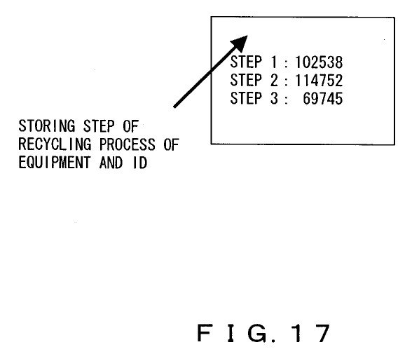

FIG. 17 shows an example of an ID associated with a disposing step stored in the memory attached to the product 22 in FIGS. 15 and 16. In this example, three disposing steps from steps 1 to 3 are required, and each step is associated with an ID value on the right.

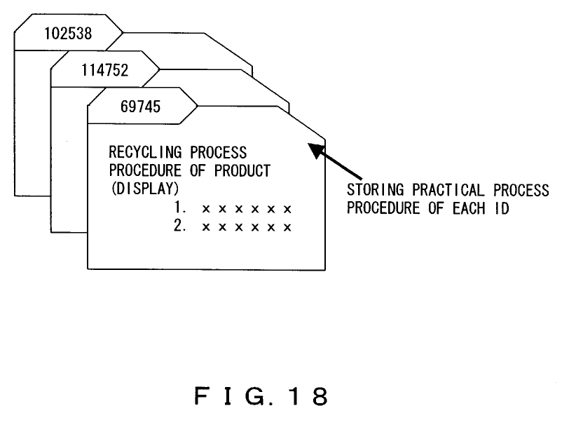

FIG. 18 is an explanatory view of the recycling processing procedure corresponding to the step shown in FIG. 17, that is, the ID. For each of the ID corresponding to each step shown in FIG. 17, normally one or more processing procedures are stored in the recycling step storage device 42 in the recycling management server 40.

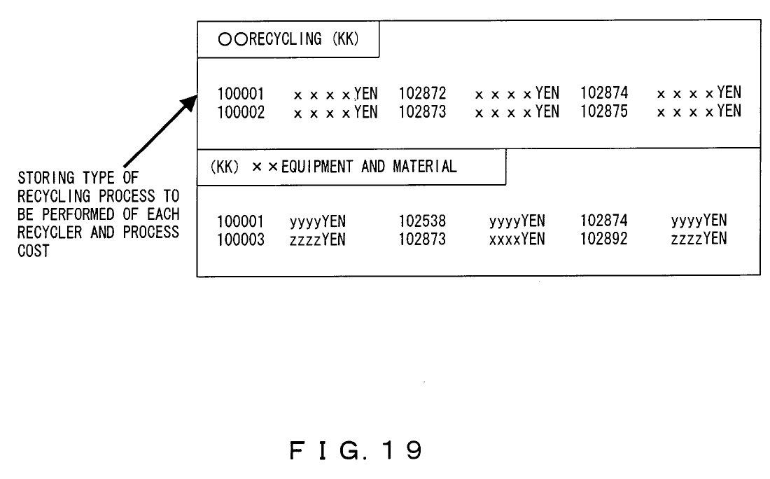

FIG. 19 shows an example of the contents stored as a disposing step which can be performed by the recycler 41. For example, a recycler referred to as a ◯ ◯ recycler is stored with combinations of an ID of a disposing step which can be performed and its processing cost.

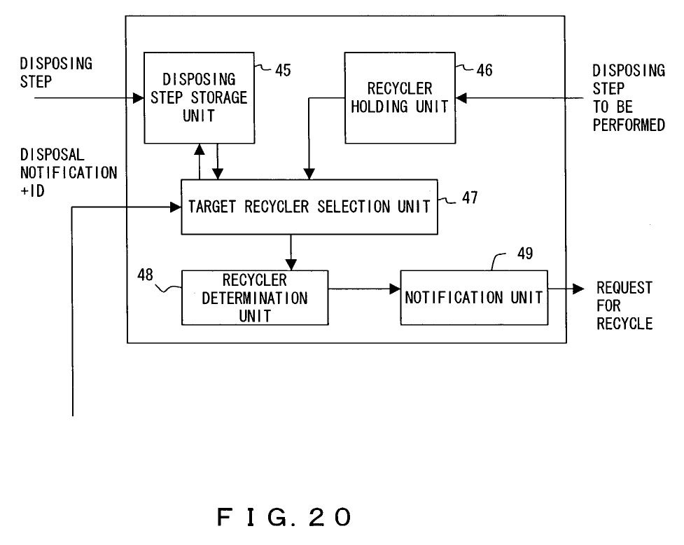

FIG. 20 is a block diagram of an example of the configuration of a recycling management server. In FIG. 20, the recycling management server 40 comprises: a disposing step storage unit 45 storing the processing procedure of each disposing step, that is, the contents shown in FIG. 18, stored by the person or organization of responsibility 20, for example, a manufacturer as shown in FIG. 15; a recycler holding unit 46 storing a disposing step stored and to be performed by the recycler 41, that is, the contents shown in FIG. 19; a target recycler selection unit 47 for selecting an appropriate recycler as a target recycler from the contents stored in the recycler holding unit 46; a recycler determination unit 48 for determining the recycler of the smallest processing cost among nomally plurality of target recycler; and a notification unit 49 for requesting the recycler to perform a recycling process.

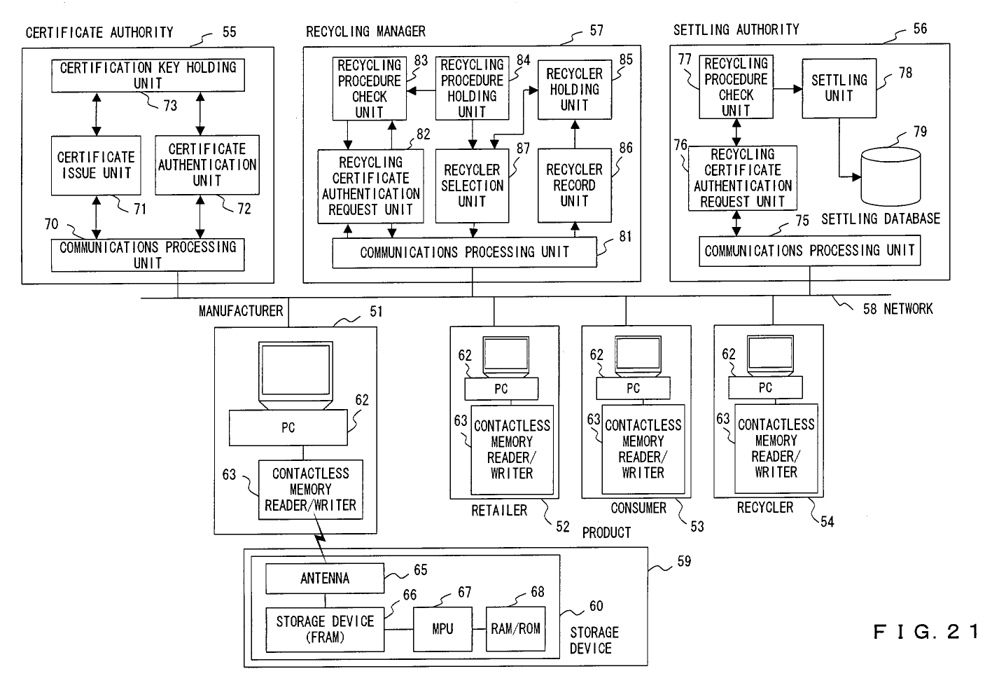

FIG. 21 is a block diagram of the entire configuration of the recycling system according to the second embodiment of the present invention. In FIG. 21, the system comprises a manufacturer 51, a retailer 52, a consumer 53, a recycler 54, a certificate authority 55, a settling authority 56, a recycling manager 57 corresponding to a recycling management server explained by referring to FIG. 15, etc., a network 58 for connecting these components, and a product 59.

Each of the manufacturer 51, the retailer 52, the consumer 53, and the recycler 54 includes a personal computer (PC) 62 and a non-contact memory reader/writer 63 for storing an electronic certificate in the product 59 and reading an electronic certificate.

The certificate authority 55 comprises: a communications processing unit 70 for performing a communicating process through the network 58; a certificate issue unit 71 for issuing a certificate to a person or organization of responsibility; a certificate authentication unit 72 for authenticating a certificate issued to the person or organization of responsibility in the processing stage and stored in the memory in the product 59; and a certification key holding unit 73 for holding a certification key required in issuing and authenticating a certificate.

The certification key used by the certificate authority 55 corresponds to a secret key in an officially established authentication bureau for authenticating an electronic document and an electronic signature. For example, a consumer confirms that the electronic certificate generated using a secret key has been issued by the certificate authority 55 using a public key.

The settling authority 56 comprises: a communications processing unit 75 for processing communications; a recycling certificate authentication request unit 76 for requesting, for example, the certificate authority 55 to authenticate an electronic certificate for recycling; a recycling procedure check unit 77 for checking whether or not the recycling procedure described above by referring to FIG. 18, etc. has been correctly performed; a settling unit 78 for paying the cost to the recycler depending on the check result of the recycling procedure check unit 77; and a settling database 79 for storing the process result.

The recycling manager 57 comprises: a communications processing unit 81; a recycling certificate authentication request unit 82 and a recycling procedure check unit 83 similar to the unit in the settling authority 56; a recycling procedure holding unit 84 corresponding to the disposing step storage unit 45 shown in FIG. 20; a recycler holding unit 85 similar to the unit shown in FIG. 20; a recycler record unit 86 for recording the disposing step to be performed by the recycler 41 in FIG. 15; and a recycler selection unit 87 corresponding to the target recycler selection unit 47 and the recycler determination unit 48.

Furthermore, a storage device 60 has the configuration not only as memory, but also as a data processing device, corresponds to the certificate R/W unit 27 and the initialization key input unit 30 shown in FIG. 14, and comprises: an antenna 65 for transmitting and receiving data to and from the non-contact memory reader/writer 63 of, for example, a manufacturer; a storage device 66, such as ferroelectric memory (corresponding to the certificate holding unit 26) for actually storing an electronic certificate, electronic money, etc.; an MPU 67 (corresponding to the erasing unit 28 and the comparison unit 31) for controlling the data processing in the storage device 60; RAM/ROM 68 (corresponding to the initialization key holding unit 29) for storing a program, etc. for use by the MPU 67.

Described below further in detail is the process performed when the payment of the recycling cost is made using electronic money by the manufacturer 51. First, the manufacturer 51 transfer the money for the recycling cost to the electronic money management authority not shown in FIG. 21, and receives electronic money to the electronic wallet not shown in the attached drawings from the electronic money management authority.

The manufacturer 51 removes the electronic money from the electronic wallet, stores the same amount of electronic money in the storage device 60 (storage device 66) of the product 59, and receives an electronic money storage certificate issued by (the MPU 67 of) the storage device 60.

The manufacturer 51 transmits the storage certificate and a (self certification) document indicating that the manufacturer has appropriately performed the recycling process to the certificate authority 55, the certificate authority 55 checks the contents described in these documents, and issues an electronic certificate to the manufacturer 51, and the manufacturer 51 stores the electronic certificate in the storage device 66 in the product 59.

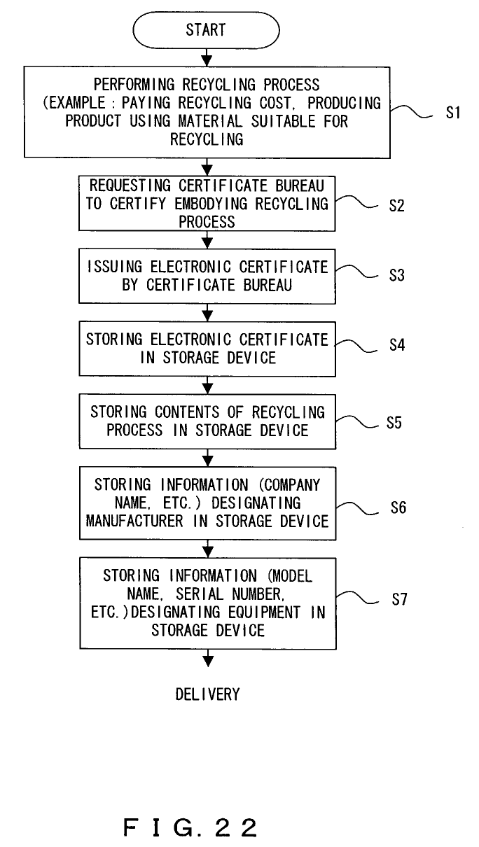

Described below is the flowchart of the process according to the present invention. FIG. 22 is a flowchart of the recycling process by a manufacturer. When the process starts as shown in FIG. 22, the recycling process of a manufacturer, for example, producing a product using a material suitable for recycling, paying a recycling cost, etc. are performed in step S1, the certificate authority (certificate bureau) is requested to certify the process in step S2, an electronic certificate is issued from the certificate authority in step S3, and the electronic certificate is stored in a storage device, for example, the memory attached to a product in step S4.

Then, in steps S5 through S7, the recycling information as described in FIG. 11 is stored in the storage device, that is, memory. First, in step S5, the contents of the recycling process, that is, the type of parts, etc. are stored. In step S6, the name of a company, etc. is stored as the information for designation of a manufacturer. In step S7, the name of a model, a serial number, etc. are stored as the information designating the equipment, that is, the product, thereby terminating the recycling process and delivering the product.

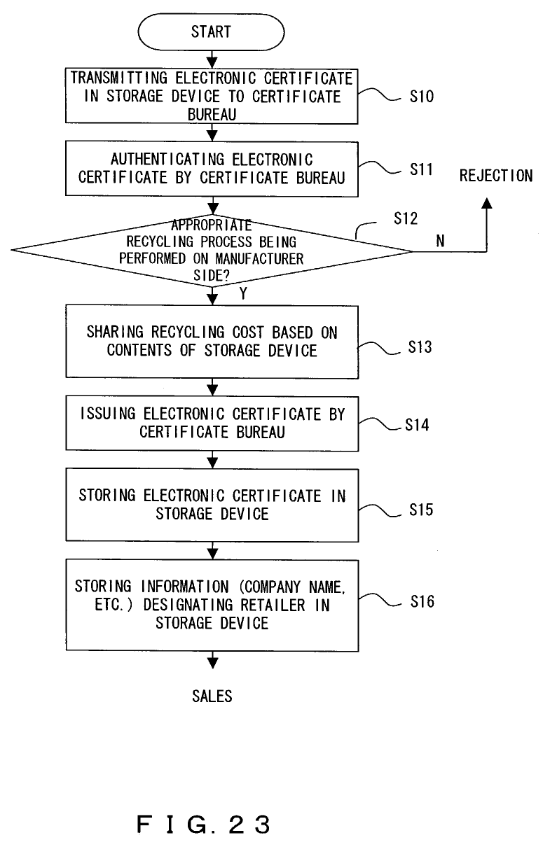

FIG. 23 is a flowchart of the recycling process by a retailer. When the process starts in FIG. 23, the electronic certificate stored in the storage device, for example, the memory attached to a product is read, and is transmitted to the certificate authority (certificate bureau) in step S10. In step S11, an authentication result of the electronic certificate is obtained from the certificate authority, and it is determined whether or not an appropriate recycling process has been performed by the manufacturer in correspondence with the authentication result in step S12. If not, the product is returned to the manufacturer, thereby terminating the process.

If it is determined that an appropriate recycling process has been performed, the cost is paid to the certificate authority depending on the recycling cost, set by, for example, the manufacturer in the storage device in step S13. In step S14, the certificate authority issues an electronic certificate. In step S15, the electronic certificate is stored in the memory. In step S16, the information designating a retailer, for example, the name of a company, etc. is stored in the memory, and the product is sold.

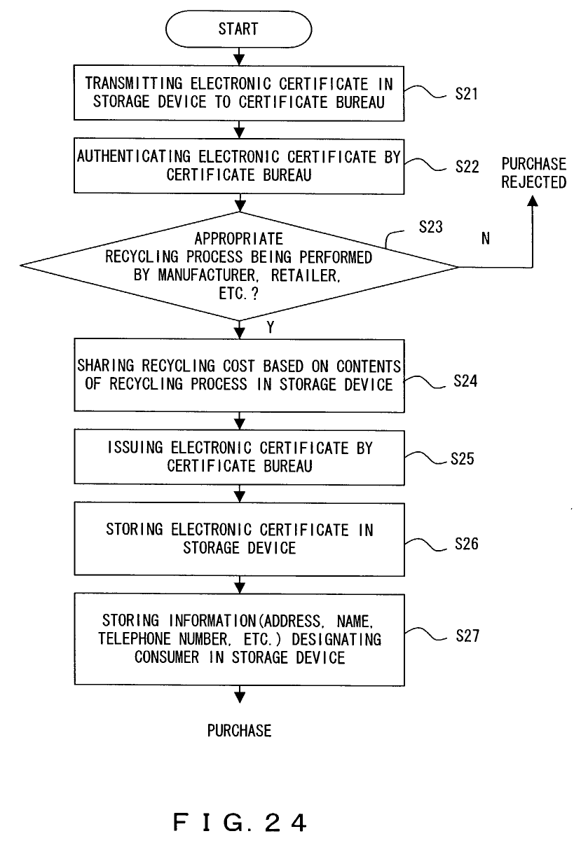

FIG. 24 is a flowchart of the recycling process by the consumer. When the process starts as shown in FIG. 24, the electronic certificate stored in a storage device, for example, the memory attached to the product is read in step S21, and transmitted to the certificate authority. In step S22, an authentication result of the electronic certificate is received from the certificate authority. In step S23, it is determined whether or not a manufacturer, a retailer, etc. have appropriately performed a recycling process. If the recycling process has not been appropriately performed, then the purchase of the product is rejected, thereby terminating the process.

If an appropriate recycling process has been performed, then a payment of a recycling cost is made to the certificate authority in step S24 depending on the contents of the recycling process, set by, for example, a manufacturer and stored in the memory, to be performed by a consumer. In step S25, an electronic certificate is issued as a result of the above mentioned processes. In step S26, the electronic certificate is stored in the memory. In step S27, the address, name, telephone number, etc. as the information designating the consumer are stored in the memory, and the product is purchased.

In step S27 shown in FIG. 24, the information designating a consumer stored in the memory is contributory to protection against burglar and theft. When the privacy of a consumer is weighed, storing the information designating a consumer can be omitted, or can be performed with an encrypting process which can only be read by an authority a consumer specifies. Storing an electronic certificate in the memory can be performed by a consumer or a retailer when the product is purchased.

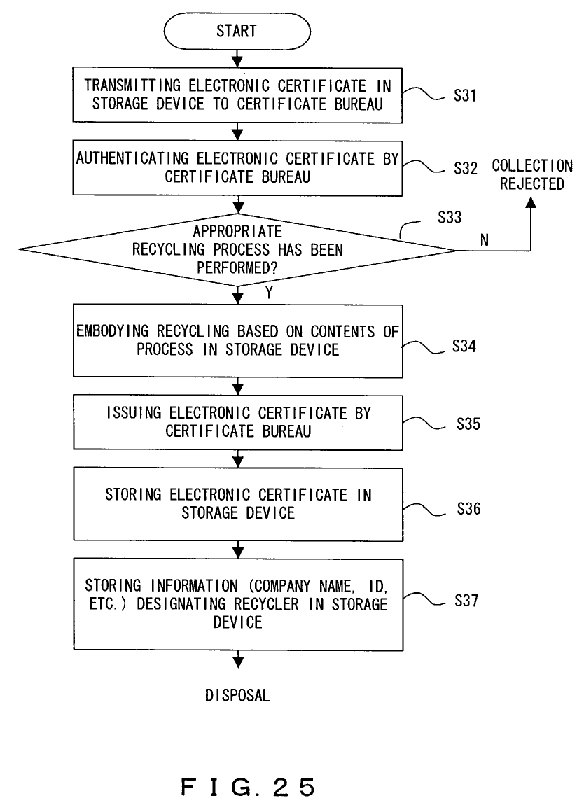

FIG. 25 is a flowchart of the recycling process by a recycler, that is, a collector and a scrapper. When the process starts as shown in FIG. 25, the electronic certificate in the storage device is transmitted to the certificate authority in step S31, the electronic certificate is authenticated in the certificate authority in step S32, and it is determined in step S33 based on the result whether or not an appropriate recycling process has been performed. If not, then the product to be disposed is rejected, thereby terminating the process.

If an appropriate process has been performed, then a process is performed in step S34 based on the contents of the recycling process stored in the storage device by, for example, a manufacturer in advance, and to be performed by the recycler. In step S35, an electronic certificate is issued by the certificate authority on the process. In step S 36, the electronic certificate is stored in the storage device. In step S37, the name and the ID of a company, etc. is stored as the information designating the recycler in the storage device, thereby terminating the process in the recycler.

For example, when a collector performs the recycling process, the product collected after the process shown in FIG. 25 is passed to a scrapper, and the scrapper performs the process shown in FIG. 25, and the product is disposed. When the scrapper disposes the product, the product normally loses its original shape. In this case, the storage device, that is, the memory attached to the product, is removed from the product and stored.

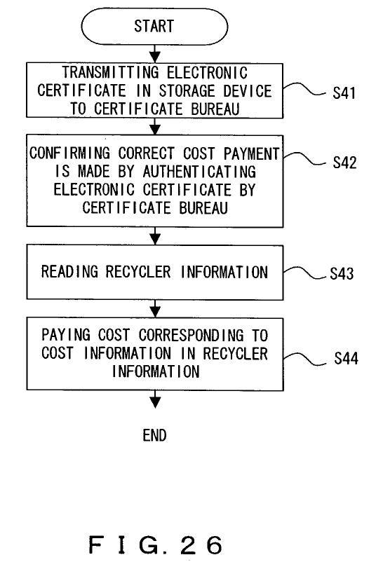

FIG. 26 is a flowchart of the settling process by a settling agent. When the process starts as shown in FIG. 26, the electronic certificate in the storage device is transmitted to the certificate authority in step S41. In FIG. 21, the settling authority 56 is not provided with a non-contact memory reader/writer for directly reading an electronic certificate stored in the storage device 60 in the product 59, but the electronic certificate in the storage device is read by, for example, the recycler 54, and is transmitted to the settling authority through the network 58.

Then, the electronic certificate is authenticated by the certificate authority in step S42, it is checked that the reservation of the payment of the cost has been correctly made. In step S43, a recycler information is read. In step S44, the cost of the cost information in the recycler information is settled in step S44, thereby terminating the process.

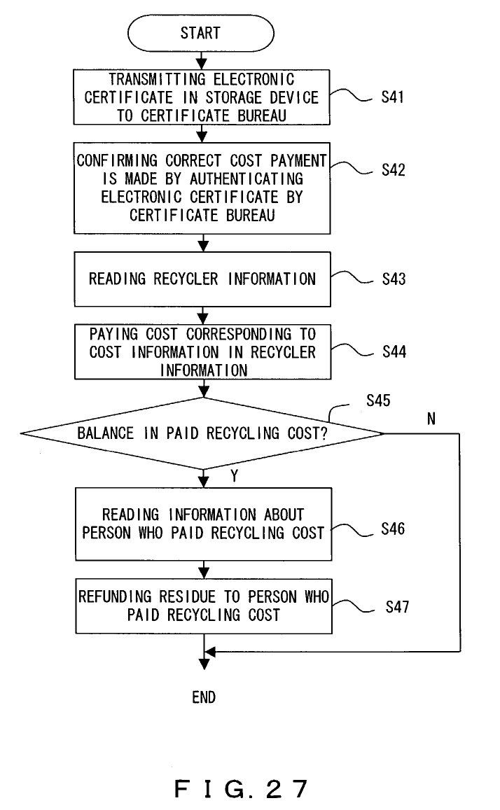

FIG. 27 is a flowchart of the settling process by the settling agent to be performed when there is a residue of the recycling cost. In FIG. 27, when the processes in steps S41 through S44 are performed similarly as shown in FIG. 26, it is determined in step S45 whether or not there is a residue of the reserve for the recycling cost. If not, the process terminates immediately.

If there is a residue, the information about the persons who paid the recycling cost, that is, normally a manufacturer, a retailer, and a consumer, is read, and the residue is refunded at an appropriate rate to the persons in step S47, thereby terminating the process. In this case, the rate can be a proportional rate depending on the shared amounts, but all the residue can be refunded to the consumer to attain the purpose of obtaining the cooperation of the consumer.

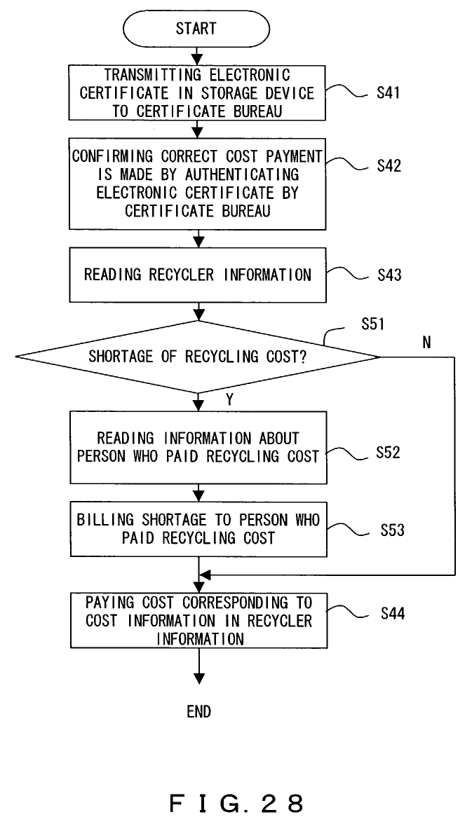

FIG. 28 is a flowchart of the settling process performed when there is a shortage of the recycling cost. In FIG. 28, after performing the processes in steps S41 through S43 as shown in FIGS. 26 and 27, it is determined in step S51 whether or not there is a shortage of the recycling cost. If there is not a shortage of the recycling cost, the cost of the cost information in the recycler information is settled in step S44, there by terminating the process.

If there is a shortage of the recycling cost, then the information about a person who paid the recycling cost is read in S52 performed similarly as in the process in step S46 shown in FIG. 27, and a shortage is billed to the person who paid the recycling cost in step S53 at an appropriate rate, and the cost payment is settled in step S44, thereby terminating the process. The bill of the shortage in step S53 can be prepared based on the proportion depending on the amount of share among a plurality of persons or organizations of responsibility as described above, but can be, for example, totally billed to the manufacturer to attain the purpose of weighing the responsibility of the manufacturer.

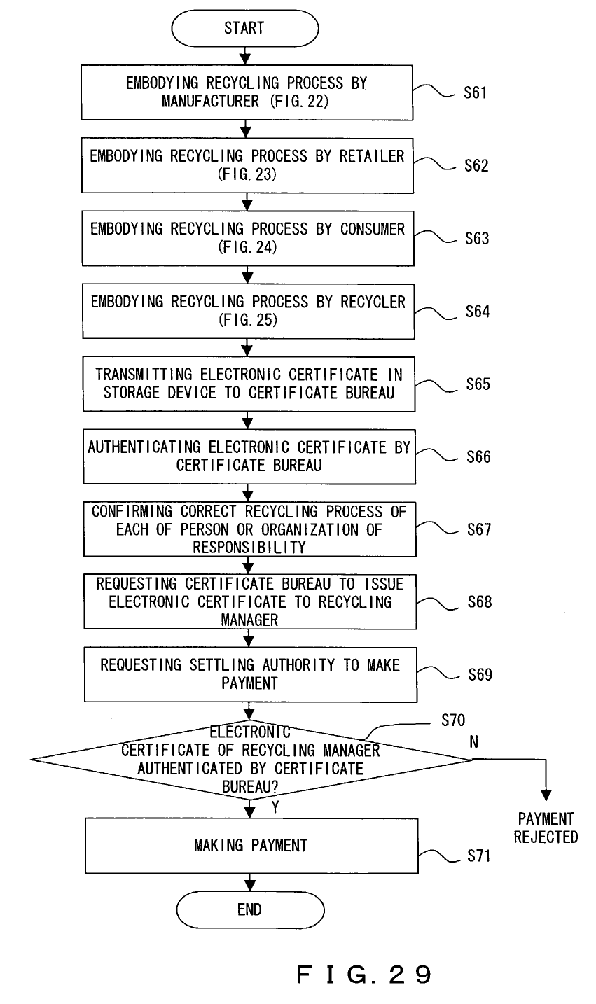

FIG. 29 is the entire flowchart of the recycling process according to the second embodiment of the present invention including the process of the recycling manager shown in FIG. 21. When the process starts as shown in FIG. 29, the recycling process is performed in step S61 by the manufacturer as described above in detail by referring to FIG. 22, the recycling process is performed in step S62 by the retailer as described above in detail by referring to FIG. 23, the recycling process is performed in step S63 by the consumer as described above in detail by referring to FIG. 24, the recycling process is performed in step S64 by the recycler as described above in detail by referring to FIG. 25.

Then, in step S65, an electronic certificate stored in the memory attached to the product is transmitted to the certificate authority, and the electronic certificate is authenticated in step S66.

The authentication result is transmitted to the recycling manager 57, that is, the recycling management server, shown in FIG. 21, it is confirmed in step S67 that each of the persons or organizations of responsibility correctly performs the recycling process, the certificate authority is requested in step S68 to issue an electronic certificate to the recycling manager, the settling authority 56 is requested in step S69 to settle the payment, the electronic certificate of the recycling manager is authenticated by the certificate authority in step S70, the settlement is rejected if the authentication result is negative, and the settlement is performed in step S71 if the authentication result indicates a correct recycling process.

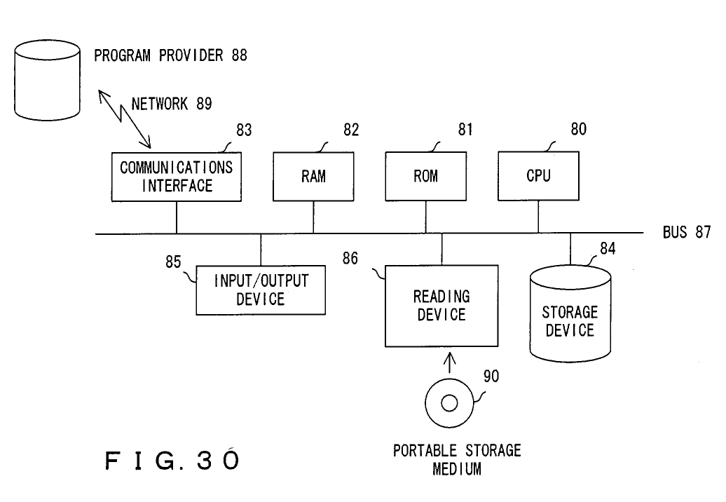

As described above, the recycling method and the recycling system have been described in detail. For example, the recycling management server shown in FIG. 15 can be configured as a common computer system. FIG. 30 is a block diagram of the configuration of the computer system, that is, the hardware environment.

In FIG. 30, the computer system comprises a central processing unit (CPU) 80, read-only memory (ROM) 81, random access memory (RAM) 82, a communications interface 83, a storage device 84, an input/output device 85, a reading device 86 for portable storage medium, and a bus 87 to which all of the above mentioned components are connected.

Storage devices of various formats such as a hard disk, a magnetic disk, etc. can be used as the storage device 84. The above mentioned storage device 84 or the ROM 81 store the program shown in the flowchart in FIGS. 22 through 29, and the program is executed by the CPU 80, thereby realizing the recycling method and the recycling system according to the embodiments of the present invention.

The program can be stored in the storage device 84 from the program provider 88 through the network 89 and the communications interface 83, or can be stored in a marketed and distributed portable storage medium 90 and set in the reading device 86 to be executed by the CPU 80. The portable storage medium 90 can be any of various storage media such as CD-ROM, a flexible disk, an optical disk, a magneto-optic disk, etc. The program stored in one of the above mentioned storage media can be read by the reading device 86 and the embodiments of the recycling method of the present invention can be realized.

As described above in detail, a shared cost of each person or organization of responsibility, such as, a manufacturer, a retailer, a consumer, etc. of a product is apparent according to the present invention, and electronic money can be stored in the memory attached to the product, thereby suppressing the occurrence of pollution by illegal dumping.

Furthermore, when the process of a scrapper who finally disposes a product is completed, the recycling cost is actually paid, that is, electronic money is paid, etc., thereby preventing a middleperson from only collecting electronic money as the settling process of paying the recycling cost without performing an appropriate disposing process.

Furthermore, by recording in advance the flow of disposal in the memory attached to a product, the cycle of disposal can be controlled when the product is produced. When illegal dumping is detected, it is possible to know in which stage the illegal dumping has been performed according to an electronic certificate stored in the memory or the process history of a certificate server provided in a certificate authority, thereby greatly contributing to a solution to recycling problems.

What is claimed is:

1. A recycling method, wherein
a person or organization of responsibility for disposal of a product in a life cycle from production to disposal of the product stores in a storage unit an electronic certificate indicating that the person or organization of responsibility has performed an appropriate process corresponding to the responsibility.

2. The method according to claim 1, wherein
said storage unit is attached to the product.

3. The method according to claim 1, wherein
said electronic certificate is issued by an officially recognized certificate authority.

4. The method according to claim 3, wherein
said certificate authority issues the electronic certificate using a certification key as a secret key.

5. The method according to claim 3, wherein
in response to a request from the person or organization of responsibility, the electronic certificate issued to another person or organization of responsibility stored in the storage unit is authenticated by the certificate authority.

6. The method according to claim 3, wherein
when the person or organization of responsibility pays to a settling authority a recycling cost as a process corresponding to the responsibility, the certificate authority stores an amount of the recycling cost in the electronic certificate in response to a notification from the settling authority.

7. The method according to claim 3, wherein
when the person or organization of responsibility requests the certificate authority to pay a recycling cost for a process performed corresponding to the responsibility of the person or organization, the certificate authority notifies a settling authority of the recycling cost, and the settling authority pays the recycling cost to the person or organization of responsibility.

8. The method according to claim 1, wherein
when the person or organization of responsibility pays to a settling authority a recycling cost for a process performed corresponding to the responsibility, the settling authority issues electronic money for the recycling cost, and the person or organization of responsibility stores the electronic money in the storage unit.

9. The method according to claim 8, wherein
a data processing unit connected to the storage unit issues an electronic money storage certificate to the person or organization of responsibility when the electronic money is stored.

10. The method according to claim 1, wherein
at a stage before a consumer purchases the product, said person or organization of responsibility stores in the storage unit data of a person or organization of responsibility associated with the disposal of the product.

11. The method according to claim 10, wherein
said data of the person or organization of responsibility associated with the disposal of the product, and stored in the storage unit is displayed to the person or organization of responsibility.

12. The method according to claim 1, wherein
said person or organization of responsibility reads and writes data from and to the storage unit using a contactless memory access device.

13. The method according to claim 1, wherein
a predetermined person or organization of responsibility of a plurality of persons or organizations of responsibility initializes contents stored in the storage unit using an initialization key.

14. A recycling system configured by a computer provided for each person or organization of responsibility when a product is disposed in a life cycle of the product from production to disposal, comprising
a recycling management server having a disposing step storage unit for storing a disposing step stored by a manufacturer of the product corresponding to one or more identifiers stored in memory attached to the product, and storing a disposing step which is stored by a recycler of a product and is to be performed by each recycler.

15. The system according to claim 14, wherein
said recycling management server further comprises a recycler selection unit for selecting a recycler of a product based on one or more identifiers stored in the memory corresponding to a notification from a consumer who determines disposal of the product.

16. The system according to claim 15, wherein:
said disposing step storage unit stores a recycling cost corresponding to the disposing step stored by the recycler of the product; and
said recycler selection unit selects a recycler based on the recycling cost.

17. The system according to claim 14, wherein
said memory attached to the product further stores an electronic certificate stored by a person or organization of responsibility for disposal of a product in a life cycle from production to disposal of the product, and indicating that the person or organization of responsibility has appropriately performed a process corresponding to the responsibility.

18. A recycling management apparatus which manages a recycling process of a product, comprising:
a unit confirming contents of an electronic certificate issued to a person or organization of responsibility for disposal of a product in a life cycle from production to disposal of the product and indicating that the person or organization of responsibility has appropriately performed a process corresponding to the responsibility;
a unit receiving from a certificate authority an electronic certificate indicating that the contents of the electronic certificate has been confirmed; and
a unit transmitting the received electronic certificate to a settling authority, and requesting the settling authority to pay a recycling cost.

19. A program executed by a computer used by a person or organization of responsibility for disposal of a product in a life cycle from production to disposal of the product to direct the computer to perform:
a procedure of receiving from a certificate authority an issue of an electronic certificate indicating that the person or organization of responsibility has appropriately performed a process corresponding to the responsibility; and
a procedure of storing the issued electronic certificate in a storage unit.

20. A computer-readable portable storage medium storing a program used to direct a computer provided by a person or organization of responsibility for disposal of a product in a life cycle from production to disposal of the product to perform:
a step of receiving from a certificate authority an issue of an electronic certificate indicating that the person or organization of responsibility has appropriately performed a process corresponding to the responsibility; and
a step of storing the issued electronic certificate in a storage unit.
